(19) United States
(12) Patent Application Publication
(10) Pub. No.: US 2008/0044269 A1
(43) Pub. Date: Feb. 21, 2008

(54) SELF-LIFT SCOOTER

(76) Inventor: Fernando Pradenas, Catherdral City, CA (US)

Correspondence Address: STEVEN W. WEBB, 655 2ND STREET, ENCINITAS, CA, 92024, US

(21) Appl. No.: 11/931,583

(22) Filed: Oct. 31, 2007

Related U.S. Application Data
(63) Continuation-in-part of application No. 10/979,025, filed on Nov. 2, 2004.

(51) Int. Cl. B60P 3/06

(52) U.S. Cl. 414/462

(57) ABSTRACT

A novel scooter lifting mechanism is proposed using a lifting motor and worm gear on the scooter itself to lift the scooter into position to be carried on a vehicle. The self-lifting scooter uses its own battery power to operate the lifting mechanism. The bracket that carries the scooter is attached to the rear of a standard automobile, and can be removed and stored in the vehicle when not in use.

### RELATED APPLICATIONS

This is a continuation-in-part application of application Ser. No. 10/979,025, which is currently copending.

### FIELD OF THE INVENTION

This invention relates to devices and means for enabling a larger vehicle to carry a smaller vehicle attached to it removably. In particular, this invention relates to devices for carrying personal mobility devices such as scooters on the back of automobiles.

### BACKGROUND OF THE INVENTION

Personal scooters are a popular means by which mobility-limited individuals can get around over long distances that would otherwise have to be walked. These scooters are transportable within other vehicles, such as a van, or attached to the rear of a car, truck, or van. The method of attachment is to have a lifter that picks up the scooter and holds it removably but securely at the back bumper.

Typical of the prior art is Jones et al. U.S. Pat. No. 5,482,424 to Jones, which teaches a hand-powered lift for wheelchairs attached to the rear of an automobile and Meyer U.S. Pat. No. 5,466,111 which shows a self-lifting wheelchair that uses the driver's door to position itself in an automobile. Steiger and Johnson in U.S. Pat. No. 4,180,363 show a self-lifting forklift that can lift or lower itself onto/off of a truck bed. All of these require complex support mechanisms or modifications to a vehicle and do not apply to personal scooters carried outside of vehicle. Jones in particular places the lifting mechanism on the support structure attached to the automobile. In none of these designs is a lifting mechanism attached to the scooter itself, powered by the scooter's own internal power source.

The present invention is a simple adaptation to an existing scooter design that uses a standard trailer hitch and support arm to attach and lift itself onto an automobile. Therefore, it is clear that the prior art for scooter lifters does not include the present solution to the scooter transportation problem.

### SUMMARY OF THE INVENTION

The present invention is an electrically-powered worm gear mechanism designed and manufactured as an integral part of a three-or-four-wheeled scooter, using the battery power of the scooter to energize the worm gear motor. The scooter can then lift itself against a fixed support arm which is attached to a transport vehicle, such as an automobile.

This invention is designed to be used with the scooter standing on its rear drive wheels with the front end elevated vertically. Releasing the rear drive wheels brakes allows the drive wheels to move freely. For the user to maneuver the scooter into the vertical position, the user lifts the scooter by the steering column while the user stops the rear wheels with his feet. Many scooter designs have rear anti-tipping wheels about one inch above the ground that will not interfere with this process.

The worm gear drive axis runs from the front of the scooter to the rear, with the worm gear motor placed at the rear of the scooter. The worm gear mechanism is an industry-standard, high-efficiency epicyclic ball screw with integral freewheeling at both the down and up stroke, eliminating limit switches and increasing reliability. The particular model used in the prototype unit has a load capacity of 500 pounds, and lifts the scooter 22 inches above the ground.

In the working prototype, he motor and worm gear were encased in a hollow, square tube comprised of steel with the front open to permit the travel of the support bracket. The motor and worm gear assembly was easily attached with “U” bolts to a standard scooter, and the invention operated easily. Other attachment means can be contemplated other than “U” bolts.

When power is applied to the lift motor, through a momentary toggle switch, it causes a bracket with attaching pin to be moved down the screw from the front of the scooter towards the rear. The attaching pin is first mated to the support arm, in the preferred embodiment inserted into a cylindrical hollow connector, before the worm gear mechanism is activated.

### DESCRIPTION OF THE DRAWINGS

FIG. 1 is a side view of the invention as it is attached to a scooter.

FIG. 2 is a side view showing how the scooter connects to an automobile.

FIG. 3 is a side view of the scooter lifting itself off the ground

FIG. 4 is a perspective view of the worm gear motor and bracket.

FIG. 5 is a perspective view of the support arm as it is attached to the automobile.

### DETAILED DESCRIPTION OF THE INVENTION

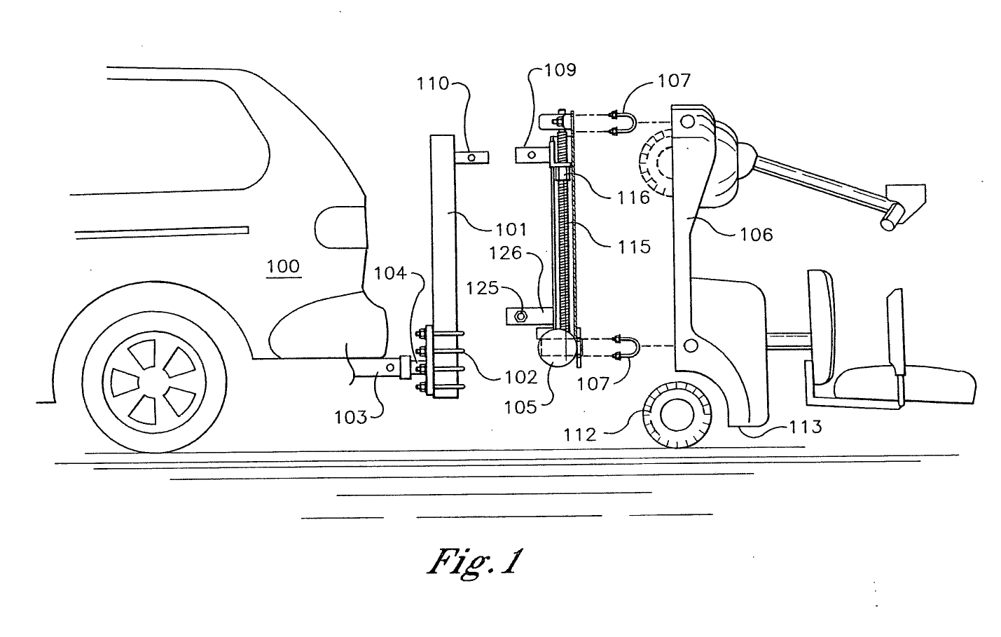

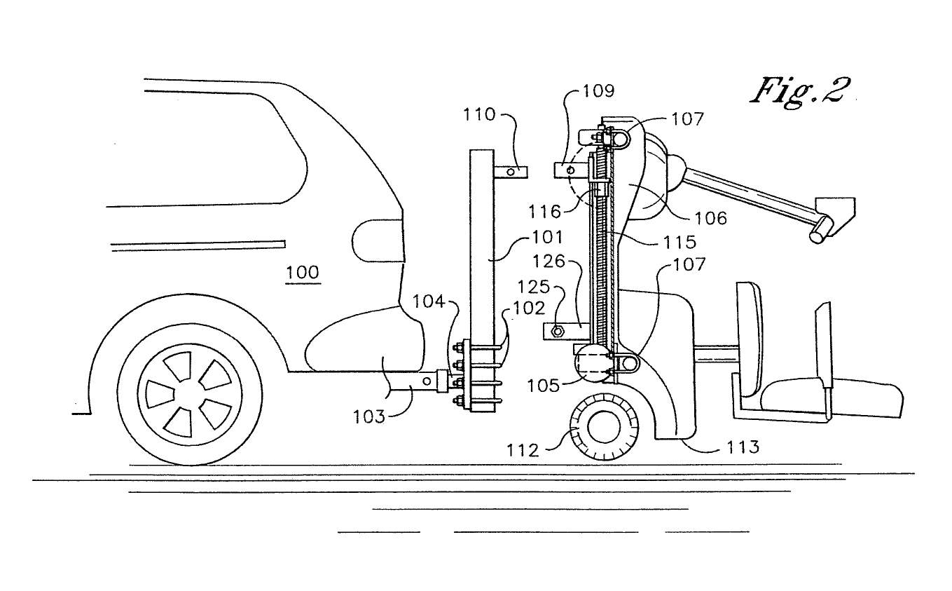

The present invention is shown in FIG. 1, consisting of a support arm101 attached via U-bolts102 to a support arm bracket104, which is connected removably to a support arm hitch103, a power lift unit105 attached fixedly to a scooter106 with U-bolts107, the power lift unit105 positioned such that it can be connected removably to the support arm101 with a support pin receiver109 and support pin110. FIG. 2 shows the entire invention assembled and ready to be used.

The U-bolts107 are used in this instantion as the means by which the power lift unit105 is attached to to the scooter, but in an alternate embodiment the power lift unit105 could be embedded into the frame of the scooter106 when the scooter is manufactured. In both embodiments, the power lift unit105 is powered by the scooter106 and its internal battery power source.

In FIG. 2, the scooter106 is tilted on its rear end113 by rotating the scooter around the rear wheels112. Optionally, the scooter rear end113 possesses caster wheels or another supplemental support mechanism, not shown in the diagrams, to aid in keeping the scooter106 in the correct orientation to be attached to the support arm101.

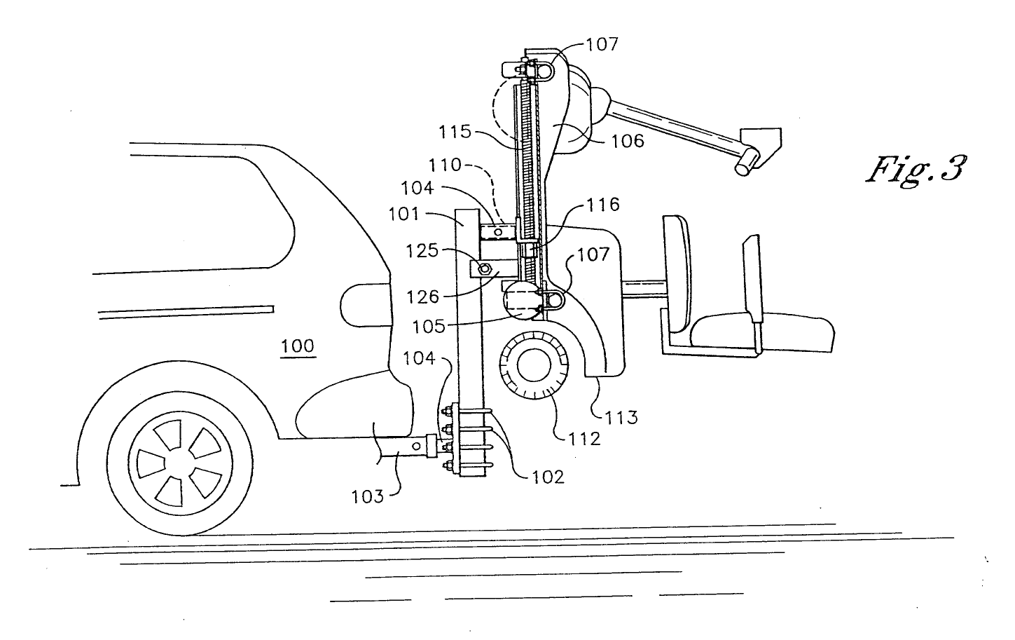

FIG. 3 shows the scooter106 in the position of having been lifted off the ground by means of the invention. The support pin110 has been inserted into the support pin receiver109 on the support arm101 and the power lift unit105 has been activated such that the worm gear115 has spun enough times to push the worm gear bracket116 with the support pin110 down the worm gear115 and lift the weight of the scooter106 into the air. The height required to keep the scooter106 clear of the ground is approximately 22 inches, which is higher than transporters/lifters in the state of the art.

To unload the scooter106, reverse the procedure. Stop the carrying vehicle100, turn on the power lift unit105 in reverse mode to lower the scooter106 to the ground. When the scooter106 reaches the ground, the support pin110 can be removed from the support pin receiver109 by pushing the scooter106 away from the carrying vehicle100. The scooter can be rotated on the rear wheels112 until the front end of the scooter is on the ground.

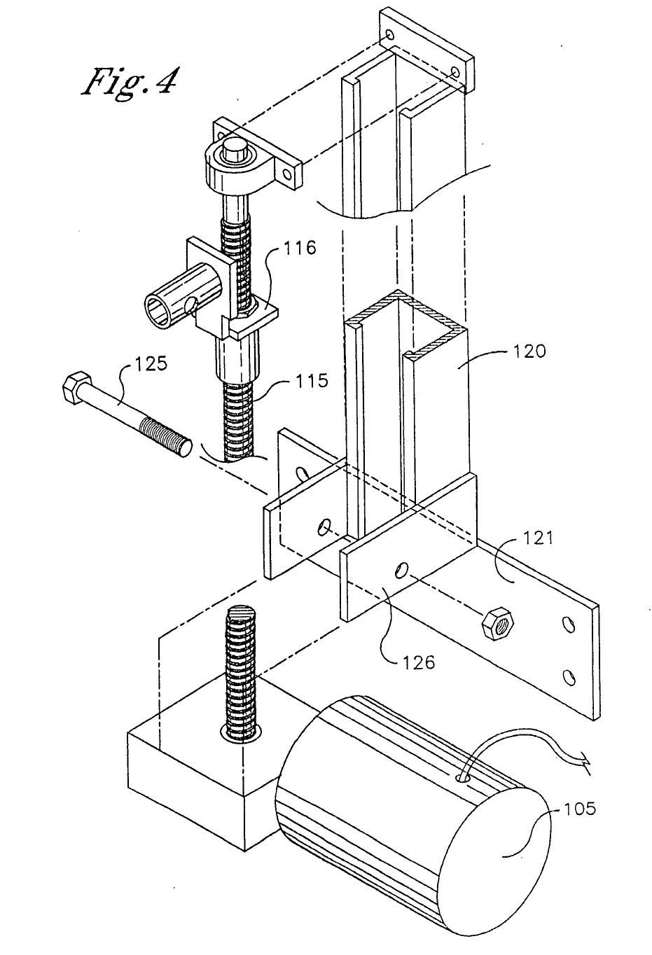

FIG. 4 shows the details of the power lift unit, with the worm gear track120 and power unit support brackets121. There is a stop bolt125 and support frame126 connected to the worm gear track120 that provides support to the weight of the scooter106 as it rides up the worm gear115. The stop bolt125 is inserted through two holes in the support frame126 and secured with a nut, as shown.

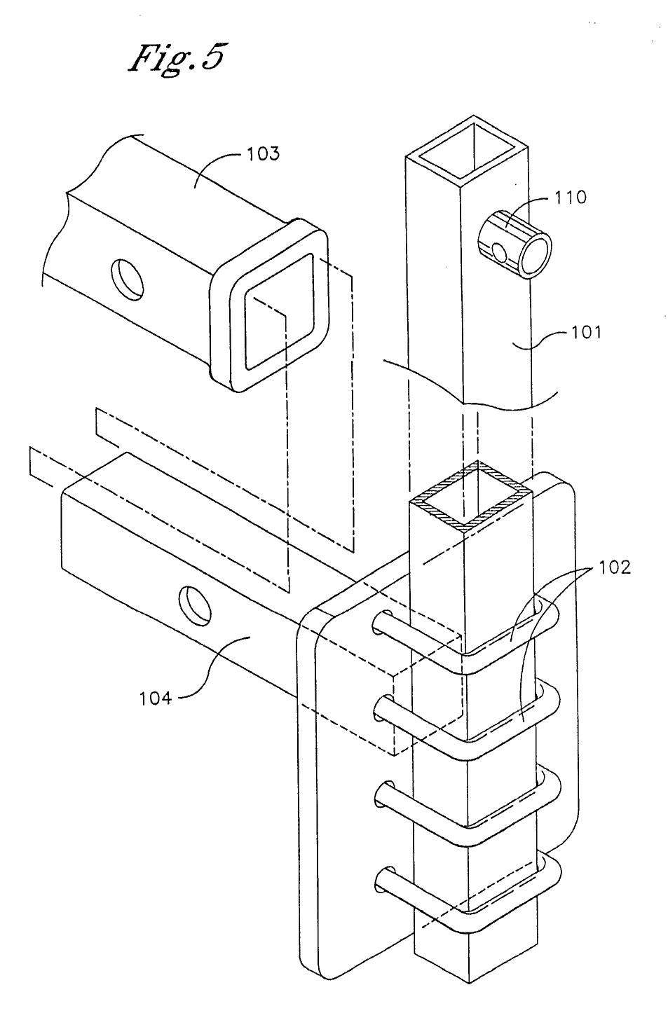

FIG. 5 shows the details of the support arm assembly attached to the carrying vehicle100. Note that the shape of the support pin110 and support pin receiver109 are cylindrical. In an alternate embodiment, these shapes could be rectangular or semicircular, or any other convenient shape.

While the present invention has been described above and a preferred embodiment of the invention has been identified, changes and substitutions of equivalent features can be made without departing from this invention. Those skilled in the art of scooter lifter will recognize that many variations of this described embodiment of the invention can be resorted to without leaving the boundaries of this specification and associated claims below.

What is claimed for this invention is:

1. A self-lifting device for scooters, said self-lifting device consisting of two assemblies,
the first assembly a support arm assembly, the support arm assembly attached removably to the rear bumper of an automobile, the support arm assembly comprised of a support arm hitch attached fixedly to the automobile, a support arm bracket connected removably to the support arm hitch, a support arm extending vertically from the support arm bracket, and a support pin at the upper end of the support arm,
the second assembly a power lift assembly, the power lift assembly attached fixedly to the underside of a scooter, the power lift assembly consisting of a power lift motor and worm gear, a worm gear bracket connected to the power lift motor and worm gear such that when the power lift motor and worm gear are turned on the worm gear bracket moves in one direction or the other along the worm gear, the worm gear bracket possessing a support pin receiver, the support pin sized in such a way that it can be easily inserted into the support pin receiver, the support pin receiver attached to the worm gear in such a way that the support pin receiver is able to support the weight of the scooter when the support pin is inserted into the support pin receiver,
a stop bolt inserted into the end of a support frame, the stop frame attached fixedly to the worm gear, the support frame extending perpendicularly from the worm gear such that the position of the stop bolt is the correct minimum distance between the worm gear and the support arm when the support arm assembly and the power lift assembly are connected to each other via the support pin and support pin receiver.

2. A method of using the self lifting device as in claim 1 comprised of the steps of
operating the power lift assembly such that the worm gear bracket is moved to the end of the worm gear nearest the front of the scooter,
rolling the scooter towards the carrying vehicle,
rotating the scooter upright around its rear wheels such that the scooter is resting on its rear end,
mating the support pin on the support arm into the support pin receiver on the worm gear bracket and securing it removably,
operating the power lift assembly in such a manner that the worm gear bracket travels towards the rear of the scooter on the worm gear and the scooter is lifted up to the desired height.

3. The self-lifting device of claim 1 where the support hitch is a standard trailer hitch.
